(19) United States
(12) Patent Application Publication
(10) Pub. No.: US 2021/0357164 A1
(43) Pub. Date: Nov. 18, 2021

(54) PROVIDING USER INTERFACE BASED ON STATUS OF CONSUMABLES FOR IMAGE FORMATION

(71) Applicant: Hewlett-Packard Development Company, L.P., Spring, TX (US)

(72) Inventors: Inhwan CHA, Seongnam-si (KR); Ki-Youn LEE, Seongnam-si (KR)

(21) Appl. No.: 17/286,087

(22) PCT Filed: Apr. 25, 2019
(86) PCT No.: PCT/US2019/029127

§ 371 Date: Apr. 16, 2021

(30) Foreign Application Priority Data
Nov. 7, 2018 (KR) 10-2018-0135914

(51) Int. Cl. G06F 3/12; G06K 15/00; G06K 15/02

(52) U.S. Cl. CPC G06F 3/1219; G06K 15/027; G06K 15/4075; G06F 3/1229

(57) ABSTRACT

A device includes a user interface device, a processor, and a memory storing instructions executable by the processor, wherein the processor executes the instructions to determine whether a toner in an image forming apparatus is required to be refilled, to determine a status of at least one consumable used in an image formation operation using a test pattern when the toner is required to be refilled, and to provide the user interface device with a user interface corresponding to the determined status of the at least one consumable.

### BACKGROUND

The life of a consumable that is used for image formation is gradually reduced as printing is repeated in an image forming apparatus. When the consumable is exhausted, a user may replace the consumable with a newly purchased consumable. Different types or kinds of consumables may be used for image formation and each consumable may have a different usage life.

### BRIEF DESCRIPTION OF DRAWINGS

Certain examples of the present disclosure will be more apparent from the following description taken in conjunction with the accompanying drawings, in which:

FIG. 1 is a diagram for explaining a printing environment including an image forming apparatus, a user device, and a server, according to an example;

FIG. 2 is a diagram for explaining an operation of each of an image forming apparatus, a user device, and a server, according to an example;

FIG. 3 is a diagram for explaining a process in which an image forming apparatus determines a status of a consumable used in an image formation operation using a test pattern when the image forming apparatus is required to refill a toner, according to an example;

FIG. 4 is a diagram for explaining a process of obtaining a test pattern formed on an intermediate transfer belt (ITB), according to an example;

FIG. 5 is a diagram for explaining a process of obtaining a test pattern output on a printing paper, according to an example;

FIG. 6 is a diagram for explaining a process in which a user device determines a status of a consumable used in an image formation operation using a test pattern when an image forming apparatus is required to refill a toner, according to an example;

FIG. 7 is a flowchart illustrating a method of providing a screen for ordering a toner refill cartridge or a consumable after determining a status of the consumable used in an image formation operation by using a test pattern in an image forming apparatus or a user device when the image forming apparatus is required to refill a toner, according to an example;

FIG. 8 is a flowchart illustrating a process of determining a status of a consumable used in an image formation operation by using a test pattern, according to an example; and

FIG. 9 is a flowchart illustrating a process of providing a user interface corresponding to a status of a consumable, according to an example.

Throughout the drawings, it should be noted that like reference numbers are used to depict the same or similar elements, features, parts, components, or structures.

### DETAILED DESCRIPTION OF EXAMPLES

Hereinafter, various examples will be described with reference to the drawings. In the following description and drawings, elements having substantially the same function and configuration are denoted by the same reference numerals, and a redundant description thereof will be omitted. Various changes and modifications of the examples described hereinafter may be implemented. In order to explain the features of the examples more accurately, a detailed explanation of matters well-known to those of ordinary skill in the art to which the following examples of the present disclosure pertain will be omitted.

The term “image forming operation” as used herein may mean any of various operations related to an image (e.g., printing, copying, scanning, or faxing), such as forming an image or creating/storing/transmitting an image file. In addition, the term “operation” may mean not only an image forming operation but also a series of processes necessary for performing an image forming operation.

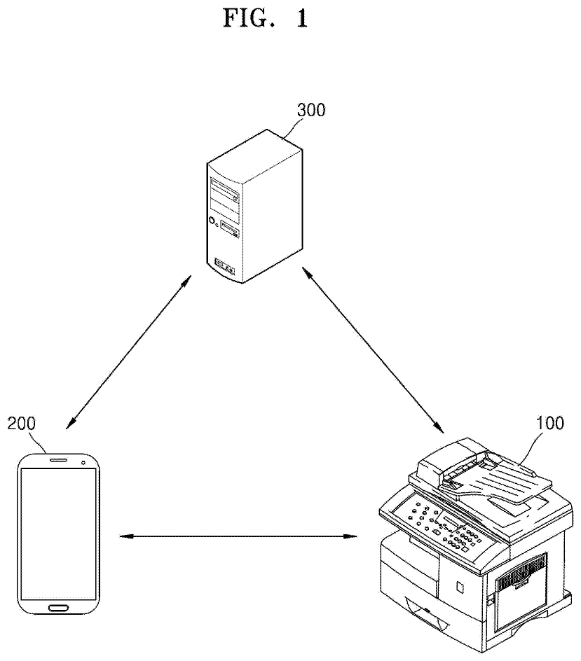

FIG. 1 is a diagram for explaining a printing environment including an image forming apparatus, a user device, and a server, according to an example.

Referring to FIG. 1, an image forming apparatus 100 may perform an image formation operation such as printing, copying, scanning, or faxing. The image forming apparatus 100 may form an image on a recording medium such as a printing paper by various printing methods such as an electrophotographic method, an inkjet method, a thermal transfer method, a thermal method, or the like. A user device 200 is an electronic device such as a smartphone, a smartwatch, a notebook, a digital camera, or the like. The user device 200 collectively refers to a device which may connect with other devices through a network to perform communication. A server 300 is a device providing a certain service. In various examples, the server 300 may provide a service such as a consumable sales server, a service center server, or the like. When requested by the image forming apparatus 100 or the user device 200, the server 300 may provide a response to the request to support a certain service.

As illustrated in FIG. 1, the image forming apparatus 100, the user device 200, and the server 300 may communicate with each other. A user may directly operate the image forming apparatus 100 or use the user device 200 to operate the image forming apparatus 100. The server 300 may provide a certain service in response to a request of the image forming apparatus 100 or the user device 200.

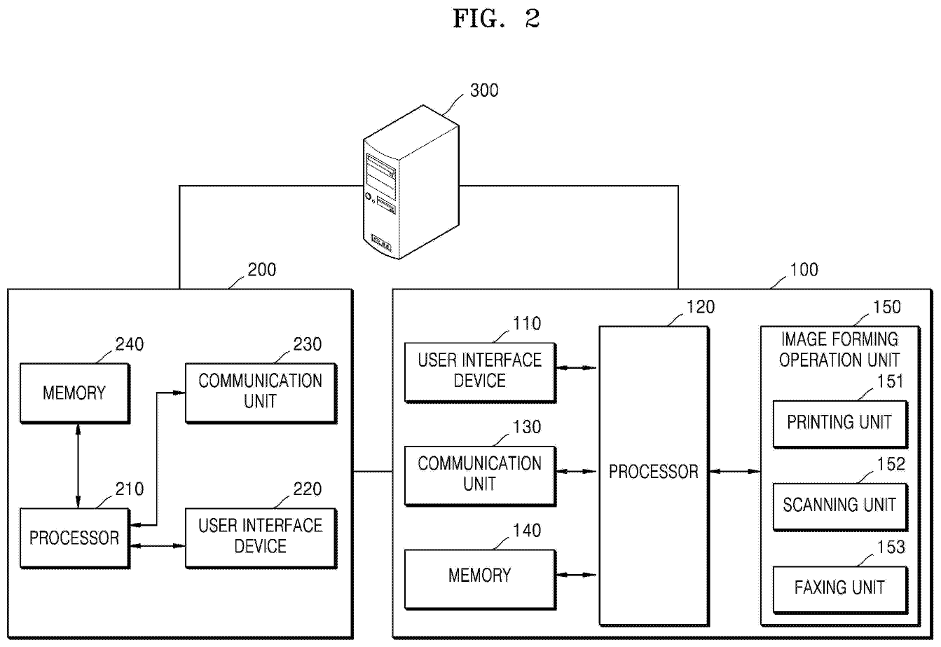

FIG. 2 is a diagram for explaining an operation of each of an image forming apparatus, a user device, and a server, according to an example.

Referring to FIG. 2, the image forming apparatus 100 may include a user interface device 110, a processor 120, a communication unit 130, a memory 140, and an image forming operation unit 150. Although not illustrated in drawings, the image forming apparatus 100 may further include a power supply unit for supplying power to each element.

The user interface device 110 may include an input unit to receive an input to perform an image formation operation and an output unit to display information such as a result of performing an image formation operation or a status of the image forming apparatus 100.

The processor 120 may control an overall operation of the image forming apparatus 100 and include at least one processor such as a central processing unit (CPU). The processor 120 may control other elements included in the image forming apparatus 100 to perform an operation corresponding to a request received through the user interface device 110 or the communication unit 130. The processor 120 may include at least one specialized processor corresponding to each function, or may be a processor integrated into one status. The processor 120 may execute programs stored in the memory 140, read data or files stored in the memory 140, or store new files in the memory 140.

The communication unit 130 may perform wired/wireless communication with other devices or networks. To this end, the communication unit 130 may include a communication module (e.g., transceiver) supporting at least one of various wired/wireless communication methods. The wireless communication may include, for example, wireless fidelity (Wi-Fi), Wi-Fi Direct, Bluetooth, Bluetooth low energy (BLE), ultra-wideband (UWB), near field communication (NFC), or the like. The wired communication may include, for example, Ethernet, universal serial bus (USB), high definition multimedia interface (HDMI), or the like.

The communication unit 130 may be connected to an external device outside the image forming apparatus 100 to transmit and receive signals or data. For example, the communication unit 130 may receive signals or data from the user device 200 or the server 300, or transmit signals or data generated in the image forming apparatus 100 to the user device 200 or the server 300. The communication unit 130 may be connected to the server 300 to obtain information provided from the server 300. In various examples, the communication unit 130 may be directly or indirectly connected to the server 300.

Various types of data such as programs and files such as applications may be installed and stored in the memory 140. The processor 120 may access and use data stored in the memory 140 or may store new data in the memory 140. In addition, the processor 120 may execute programs installed in the memory 140. The processor 120 may install, in the memory 140, an application received from an external source through the communication unit 130.

The image forming operation unit 150 may perform image formation operations such as printing, copying, scanning, or faxing. As illustrated in FIG. 2, the image forming operation unit 150 is shown as including a printing unit 151, a scanning unit 152, and a faxing unit 153. However, the image forming operation unit 150 may include, as required, some of these elements or may further include other elements for performing other types of image formation operations.

The user device 200 may include a processor 210, a user interface device 220, a communication unit 230, and a memory 240.

The processor 210 may control an overall operation of the user device 200 and may include at least one processing unit such as a CPU. The processor 210 may control other elements included in the user device 200 to perform an operation corresponding to a user input received via the user interface device 220. The processor 210 may include at least one specialized processing unit corresponding to each function. The processor 210 may execute programs stored in the memory 240, read data or files stored in the memory 240, or store new files in the memory 240.

The user interface device 220 may include an input unit to obtain a user's input and an output unit to provide information to the user. For example, the input unit may include an operation panel to receive a user's operations, or a microphone to obtain a user's voice. The output unit may include a display panel to display a screen or a speaker.

The user device 200 may be connected to an external device such as the image forming apparatus 100 or the server 300 through the communication unit 230. To this end, the communication unit 230 may support Wi-Fi, Wi-Fi Direct, Bluetooth, BLE, UWB, NFC, third generation wireless mobile telecommunications technology (3G), fourth generation wireless mobile telecommunications technology (4G), or fifth generation wireless mobile telecommunications technology (5G).

The memory 240 may store instructions executable by the processor 210. Various types of data such as programs and files such as applications may be installed and stored in the memory 240.

The server 300 may include a memory, a processor, and a communication unit. The server 300 may store information related to a service provided by the server 300 or information received from an external device. The server 300 may include at least one processing unit. The server 300 may include a communication module corresponding to the communication unit 130 of the image forming apparatus 100 or the communication unit 230 of the user device 200 so as to perform communication.

As the image forming apparatus 100 repeats the image formation operations, consumables used for the image formation operations are expended and eventually exhausted, thus reaching the end of their usage life. For example, when toner contained in a developing device is consumed as data is output to a printing medium and a remaining amount of toner falls below a certain level, an instruction message requesting a user to refill the toner may be output. Accordingly, the user may purchase a toner refill cartridge and refill the toner in the image forming apparatus 100. However, due to deterioration or depletion of other consumables used in the image formation operations, the number of available printings may not be the same as a rated amount of the toner refill cartridge. For example, when the toner in the image forming apparatus 100 is refilled by purchasing a toner refill cartridge rated for 5,000 print sheets but only 2,000 sheets may be printed due to the deterioration or depletion of other consumables such as a photoconductor, a user may be inconvenienced by an unexpected printing interruption.

Hereinafter, an example of providing a screen for ordering a toner refill cartridge or a consumable after determining a status of consumables used in an image formation operation by using a test pattern by the image forming apparatus 100 or the user device 200 before purchasing a toner refill cartridge when a toner in the image forming apparatus 100 needs to be refilled will be explained.

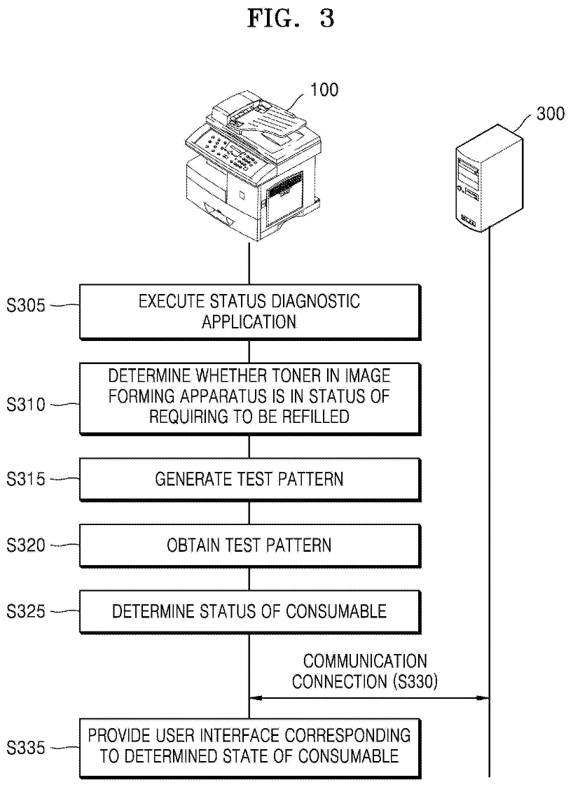

FIG. 3 is a diagram for explaining a process in which an image forming apparatus determines a status of a consumable used in an image formation operation using a test pattern when the image forming apparatus is required to refill a toner, according to an example.

Referring to FIG. 3, the image forming apparatus 100 may receive a request for executing a status diagnostic application and may execute the status diagnostic application in operation S305. However, even when there is no request for executing the status diagnostic application, the status diagnostic application may be executed or a status diagnostic function installed in the image forming apparatus 100 may be performed when a certain condition is satisfied.

The image forming apparatus 100 may determine whether toner in the image forming apparatus 100 is in a status of requiring to be refilled in operation S310. For example, the image forming apparatus 100 may determine whether a remaining amount of toner in a ready status of the image forming apparatus 100 is less than a certain amount and determine whether a request for executing a diagnosis on a status of at least one consumable is received from a user. To this end, the image forming apparatus 100 may determine the remaining amount of toner and provide the user interface device 110 with a user interface for confirming the user's intention.

The image forming apparatus 100 may generate a test pattern to be formed on a photoconductor or an intermediate transfer belt when the toner is required to be refilled in operation S315. To this end, the image forming apparatus 100 may store the test pattern in advance or may receive the test pattern from an external source.

The image forming apparatus 100 may obtain a test pattern formed on the photoconductor or the intermediate transfer belt or a test pattern output on a printing paper in operation S320. For example, the image forming apparatus 100 may use an image sensor to obtain the test pattern formed on the photoconductor or the intermediate transfer belt, or may scan or capture an image of the test pattern output on the printing paper.

The image forming apparatus 100 may determine a status of at least one consumable used in an image formation operation using the test pattern in operation S325. The image forming apparatus 100 may estimate a usage life of at least one consumable used in the image formation operation based on the obtained test pattern. For example, with respect to the obtained test pattern, the image forming apparatus 100 may obtain a frequency signal through a Fourier transform and may set a certain threshold value for each spatial frequency to identify a periodic component of the spatial frequency exceeding the threshold value. Alternatively, the image forming apparatus 100 may analyze the test pattern through a comparison between an average value, a standard deviation, and an average value of each of a plurality of test patterns with respect to the obtained test pattern. Based on defects detected in an image quality of the obtained test pattern, the image forming apparatus 100 may determine whether there is an abnormality such as a degree of abrasion, failure, or fault of at least one consumable such as a photoconductor, an intermediate transfer belt, or a developing device to estimate a usage life of the consumable. To determine a status of a consumable based on the obtained test pattern, the image forming apparatus 100 may be provided with, in advance, a mapping table in which a phenomenon detected in the test pattern, a measured value related to the detected phenomenon, and a consumable related to the detected phenomenon correspond to each other. The image forming apparatus 100 may evaluate an overall status of the image forming apparatus 100 by considering all estimated values based on the test pattern with respect to consumables used in the image formation operation.

The image forming apparatus 100 may perform a communication connection with the server 300, which sells or otherwise supplies at least one consumable used in the image formation operation in operation S330. In an example, the image forming apparatus 100 may provide the server 300 with information regarding the toner refill cartridge, such as an identifier (e.g., model number), a quantity of toner, a color, or the like. When the image forming apparatus 100 determines that it is required to purchase or otherwise receive a toner refill cartridge or at least one consumable used in the image formation operation based on the status on the consumables, the image forming apparatus 100 may perform the communication connection with the server 300 to receive sales or other information from the server 300.

The image forming apparatus 100 may provide a user interface corresponding to the determined status of the consumables in operation S335. For example, the image forming apparatus 100 may confirm an estimated usage life of at least one consumable used in the image formation operation to provide a screen for ordering a toner refill cartridge when a first condition is satisfied and a screen for ordering a consumable whose usage life is estimated to be less than a certain amount when a second condition is satisfied. For example, the first condition may indicate that all of the estimated usage life of the consumables used in the image formation operation is greater than a certain amount corresponding to each consumable. The second condition may indicate that at least one of the estimated usage life of the consumables used in the image formation operation is less than a certain amount corresponding to each consumable.

The image forming apparatus 100 may perform an image optimization process for performing an image formation operation when a user does not order a toner refill cartridge or a consumable on the screen for ordering the toner refill cartridge or the screen for ordering the consumable. For example, the image forming apparatus 100 may determine an image adjustment value for an optimal image formation operation using the test pattern for determining the status of the consumable or a new test pattern and apply the determined image adjustment value to the image forming apparatus 100. Therefore, the image forming apparatus 100 may diagnose and improve problems that may have occurred or may occur in a current status.

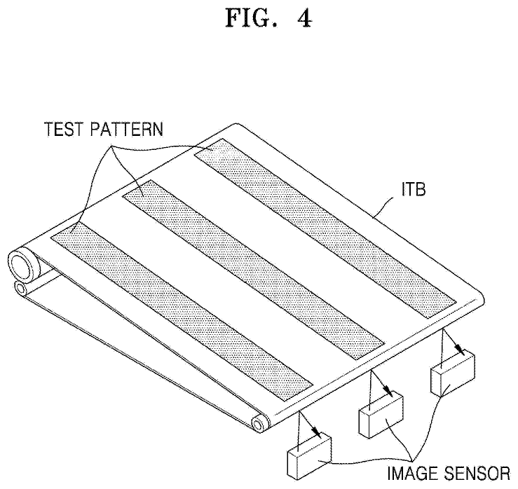

FIG. 4 is a diagram for explaining a process of obtaining a test pattern formed on an intermediate transfer belt (ITB), according to an example.

Referring to FIG. 4, test patterns are formed on the ITB. As an example, test patterns formed on a photoconductor are transferred (i.e., intermediate transfer) onto the ITB, and the test patterns are formed on the ITB. The test patterns formed on the ITB may be detected by image sensors positioned to face one side of a main scanning direction of the ITB according to a movement of the ITB. As shown in FIG. 4, there may be a plurality of image sensors so as to correspond to each of a plurality of patterns of the test patterns. The image sensors may detect the test patterns on the ITB, the test patterns being rotationally moved by the ITB. The image forming apparatus 100 may obtain a test pattern detected by an image sensor from the image sensor.

The image forming apparatus 100 may use an image sensor positioned to face a photoconductor to obtain a test pattern formed on the photoconductor before performing the intermediate transfer.

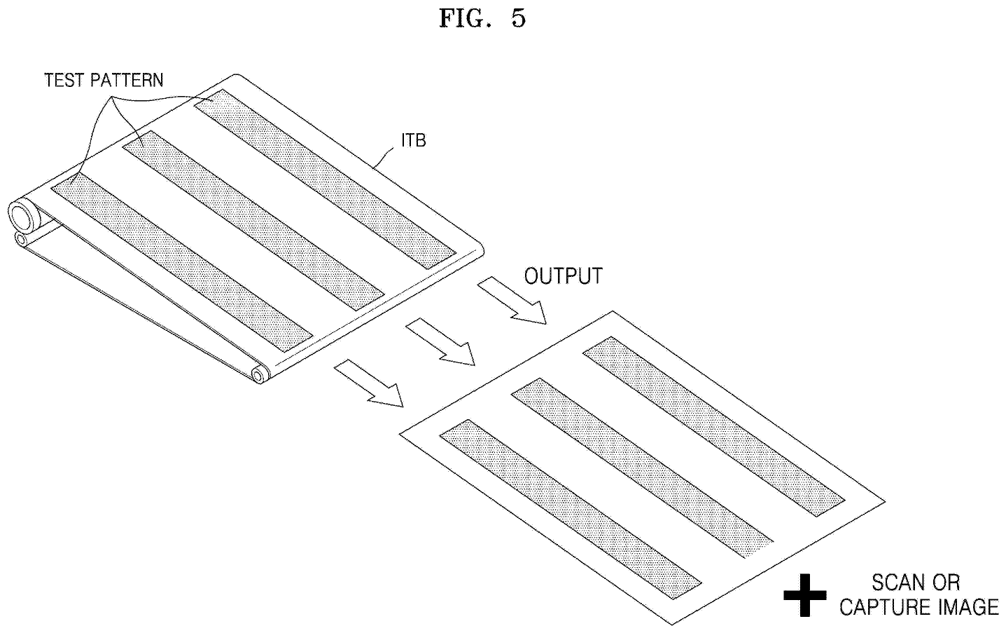

FIG. 5 is a diagram for explaining a process of obtaining a test pattern output on a printing paper, according to an example.

Referring to FIG. 5, test patterns formed on the ITB are output on a printing paper. The test patterns intermediate-transferred from the photoconductor to the ITB are transferred to the printing paper and may be output on the printing paper. The test patterns output on the printing paper may be obtained by scanning or capturing an image. For example, the image forming apparatus 100 may obtain the test patterns by scanning the printing paper on which the test patterns are output or the user device 200 may capture an image of the printing paper on which the test patterns are output.

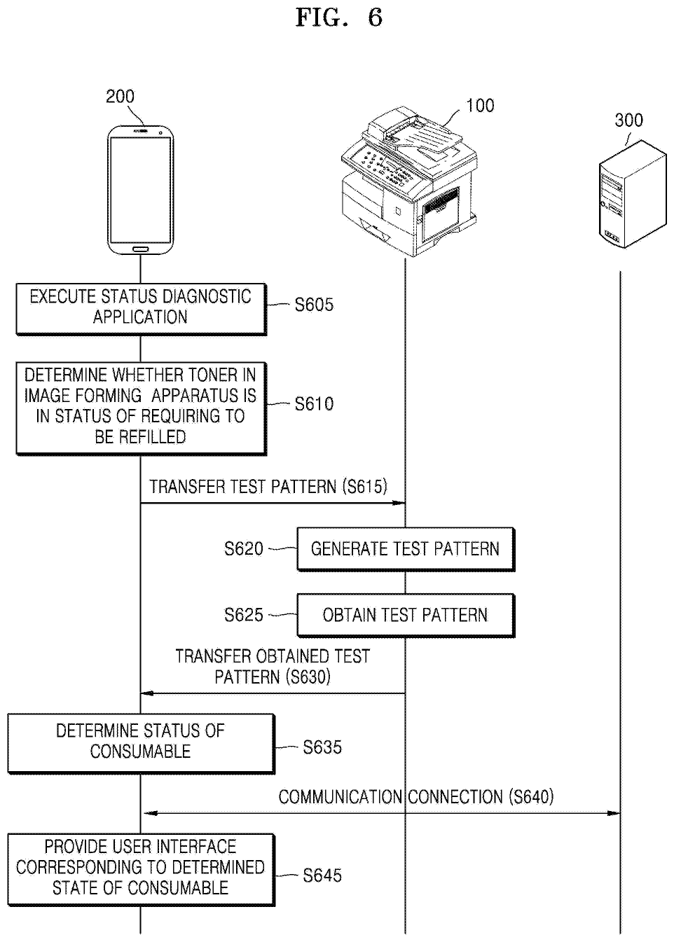

FIG. 6 is a diagram for explaining a process in which a user device determines a status of a consumable used in an image formation operation using a test pattern when an image forming apparatus is required to refill a toner, according to an example.

Referring to FIG. 6, the user device 200 may receive a request for executing a status diagnostic application and may execute the status diagnostic application in operation S605. However, even when there is no request for executing the status diagnostic application, the status diagnostic application may be executed or a status diagnostic function installed in the user device 200 may be performed when a certain condition is satisfied.

The user device 200 may determine whether toner in the image forming apparatus 100 is in a status of requiring to be refilled in operation S610. For example, the user device 200 may determine whether a remaining amount of toner in a ready status of the image forming apparatus 100 is less than a certain amount and determine whether a request for executing a diagnosis on a status of at least one consumable is received from a user. To this end, the user device 200 may request information with respect to the remaining amount of toner in the image forming apparatus 100 and may provide the user interface device 220 with a user interface for confirming the user's intention.

The user device 200 may transfer a test pattern to be formed on the photoconductor or the ITB to the image forming apparatus 100 when the toner is required to be refilled in operation S615. To this end, the user device 200 may store the test pattern in advance or may receive the test pattern from an external source.

The image forming apparatus 100 may generate a test pattern to be formed on the photoconductor or the ITB based on the test pattern received from the user device 200 in operation S620.

The image forming apparatus 100 may obtain a test pattern formed on the photoconductor or the ITB or a test pattern output on a printing paper in operation S625. For example, the image forming apparatus 100 may use an image sensor to obtain the test pattern formed on the photoconductor or the ITB, or may scan or capture an image of the test pattern output on the printing paper. In another example, the test pattern output on the printing paper may be captured by the user device 200.

The image forming apparatus 100 may transfer the obtained test pattern to the user device 200. The user device 200 may receive the test pattern transferred from the image forming apparatus 100 to obtain the test pattern in operation S630.

The user device 200 may determine a status of at least one consumable used in an image formation operation using the test pattern in operation S635. The user device 200 may estimate a usage life of at least one consumable used in the image formation operation based on the obtained test pattern. For example, with respect to the obtained test pattern, the user device 200 may obtain a frequency signal through a Fourier transform and may set a certain threshold value for each spatial frequency to identify a periodic component of the spatial frequency exceeding the threshold value. Alternatively, the user device 200 may analyze the test pattern through a comparison between an average value, a standard deviation, and an average value of each of a plurality of test patterns with respect to the obtained test pattern. Based on defects detected in an image quality of the obtained test pattern, the user device 200 may determine whether there is an abnormality such as a degree of abrasion, failure, or fault of at least one consumable such as a photoconductor, an intermediate transfer belt, and a developing device to estimate a usage life of the consumable. To determine a status of a consumable based on the obtained test pattern, the user device 200 may be provided with, in advance, a mapping table in which a phenomenon detected in the test pattern, a measured value related to the detected phenomenon, or a consumable related to the detected phenomenon correspond to each other. The user device 200 may evaluate an overall status of the image forming apparatus 100 by considering all estimated values based on the test pattern with respect to consumables used in the image formation operation.

The user device 200 may perform a communication connection with the server 300, which sells or otherwise supplies at least one consumable used in the image formation operation in operation S640. In an example, the user device 200 may provide the server 300 with information regarding the toner refill cartridge, such as an identifier (e.g., model number), a quantity of toner, a color, or the like. When the user device 200 determines that it is required to purchase or otherwise receive a toner refill cartridge or at least one consumable used in the image formation operation based on the status on the consumables, the user device 200 may perform the communication connection with the server 300 to receive sales or other information from the server 300.

The user device 200 may provide a user interface corresponding to the determined status of the consumables in operation S645. For example, the user device 200 may confirm an estimated usage life of at least one consumable used in the image formation operation to provide a screen for ordering a toner refill cartridge when a first condition is satisfied and a screen for ordering a consumable whose usage life is estimated to be less than a certain amount when a second condition is satisfied. For example, the first condition may indicate that all of the estimated usage life of the consumables used in the image formation operation is greater than a certain amount corresponding to each consumable. The second condition may indicate that at least one of the estimated usage life of the consumables used in the image formation operation is less than a certain amount corresponding to each consumable.

The user device 200 may perform an image optimization process for performing an image formation operation when a user does not order a toner refill cartridge or a consumable on the screen for ordering the toner refill cartridge or the screen for ordering the consumable. For example, the user device 200 may determine an image adjustment value for an optimal image formation operation using the test pattern for determining the status of the consumable or a new test pattern and transfer the determined image adjustment value to the image forming apparatus 100 to be applied to the image forming apparatus 100.

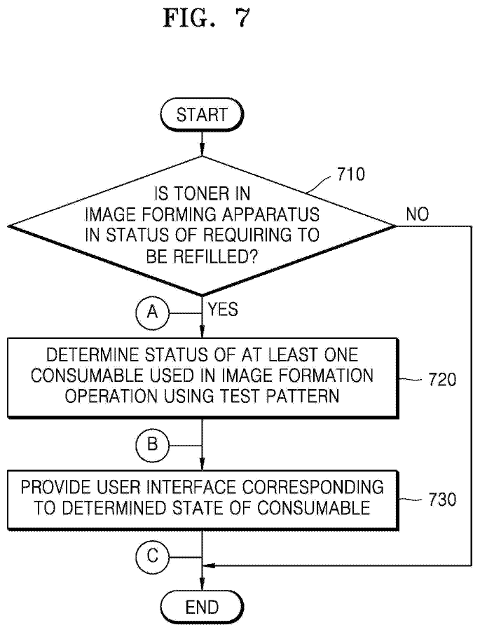

FIG. 7 is a flowchart illustrating a method of providing a screen for ordering a toner refill cartridge or a consumable after determining a status of the consumable used in an image formation operation by using a test pattern in an image forming apparatus or a user device when the image forming apparatus is required to refill a toner, according to an example.

Hereinafter, even though descriptions are omitted, the above description may be applied to methods described in FIGS. 7 to 9.

Referring to FIG. 7, the image forming apparatus 100 or the user device 200 may determine whether toner in the image forming apparatus 100 is in a status of requiring to be refilled in operation 710. For example, the image forming apparatus 100 or the user device 200 may determine whether a remaining amount of toner in a ready status of the image forming apparatus 100 is less than a certain amount and determine whether a request of executing a diagnosis on a status of at least one consumable is received from a user.

In operation 720, the image forming apparatus 100 or the user device 200 may determine a status of at least one consumable used in an image formation operation using a test pattern when the toner is required to be refilled.

In operation 730, the image forming apparatus 100 or the user device 200 may provide a user interface corresponding to the determined status of the consumable.

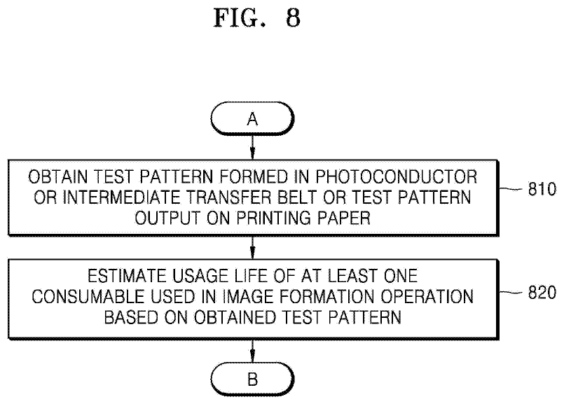

FIG. 8 is a flowchart illustrating a process of determining a status of a consumable used in an image formation operation by using a test pattern, according to an example.

Referring to FIG. 8, the image forming apparatus 100 or the user device 200 may use an image sensor to obtain the test pattern formed on the photoconductor or the ITB, or may scan or capture an image of the test pattern output on the printing paper in operation 810.

In operation 820, the image forming apparatus 100 or the user device 200 may estimate a usage life of at least one consumable used in the image formation operation based on the obtained test pattern.

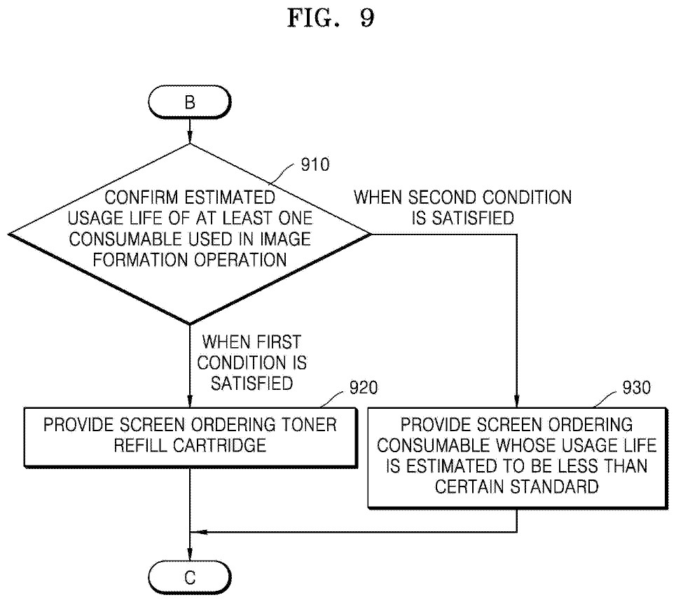

FIG. 9 is a flowchart illustrating a process of providing a user interface corresponding to a status of a consumable, according to an example.

Referring to FIG. 9, the image forming apparatus 100 or the user device 200 may confirm an estimated usage life of at least one consumable used in an image formation operation in operation 910.

In operation 920, the image forming apparatus 100 or the user device 200 may provide a screen for ordering a toner refill cartridge when the first condition is satisfied.

In operation 930, the image forming apparatus 100 or the user device 200 may provide a screen for ordering a consumable whose usage life is estimated to be less than a certain amount, when the second condition is satisfied.

The image forming apparatus 100 or the user device 200 may perform an image optimization process for performing an image formation operation when a user does not order a toner refill cartridge or a consumable on the screen for ordering the toner refill cartridge or the screen for ordering the consumable. For example, the image forming apparatus 100 or the user device 200 may determine an image adjustment value performing an image formation operation using the test pattern for determining the status of the consumable or a new test pattern and apply the determined image adjustment value to the image forming apparatus 100.

The foregoing examples and advantages are merely exemplary and are not to be construed as limiting the present disclosure. The present teaching can be readily applied to other types of apparatuses. Also, the description of the examples of the present disclosure is intended to be illustrative, and not to limit the scope of the claims, and many alternatives, modifications, and variations will be apparent to those skilled in the art.

The above description may be implemented in the form of a non-transitory computer-readable storage medium storing instructions or data executable by a computer or a processor. The examples may be written as computer programs and may be implemented in general-use digital computers that execute the programs using a computer-readable storage medium. Examples of the computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs. BD-REs, magnetic tapes, floppy disks, magneto-optical data storage devices, optical data storage devices, hard disk, solid-status disk (SSD), and instructions or software, associated data, data files, and data structures, and any device capable of providing instructions or software, associated data, data files, and data structures to a processor or a computer such that the processor or computer may execute instructions.

What is claimed is:

1. A device comprising:
a user interface device;
a processor; and
a memory storing instructions executable by the processor,
wherein the processor executes the instructions to:
determine whether a toner in the image forming apparatus is required to be refilled,
determine a status of at least one consumable used in an image formation operation using a test pattern when the toner is required to be refilled, and
provide the user interface device with a user interface corresponding to the determined status of the at least one consumable.

2. The device of claim 1, wherein the processor further executes the instructions to:
obtain a test pattern formed on a photoconductor or an intermediate transfer belt by using an image sensor or obtain a test pattern output on a printing paper by scanning or capturing an image, and
estimate a usage life of at least one consumable used in the image formation operation based on the obtained test pattern.

3. The device of claim 2, wherein the processor further executes the instructions to provide a screen for ordering a toner refill cartridge to the user interface device when an estimated result satisfies a first condition or to provide a screen for ordering a consumable whose usage life is estimated to be less than a certain amount to the user interface device when an estimated result satisfies a second condition.

4. The device of claim 3, wherein the processor further executes the instructions to perform an image optimization process for the image formation operation when a user does not order the toner refill cartridge or the consumable on the screen for ordering the toner refill cartridge or the screen for ordering the consumable.

5. The device of claim 4, wherein the processor further executes the instructions to:
determine an image adjustment value for the image formation operation using the test pattern or a new test pattern, and
apply the determined image adjustment value to an image forming apparatus to perform the image optimization process.

6. The device of claim 1, wherein the processor further executes the instructions to:
determine whether a remaining amount of the toner in a ready status of the image forming apparatus is less than a certain amount, and
determine whether a request of executing a diagnosis on a status of at least one consumable is received from a user.

7. The device of claim 1, wherein the device comprises an image forming apparatus or a user device capable of communicating with the image forming apparatus.

8. A method comprising:
determining whether a toner in an image forming apparatus is in a status of requiring to be refilled;
determining a status of at least one consumable used in an image formation operation using a test pattern when the toner is in the status of requiring to be refilled; and
providing a user interface corresponding to the determined status of the at least one consumable.

9. The method of claim 8, wherein the determining of the status of at least one consumable comprises:
obtaining a test pattern formed on a photoconductor or an intermediate transfer belt by using an image sensor or obtaining a test pattern output on a printing paper by scanning or capturing an image; and
estimating a usage life of at least one consumable used in the image formation operation based on the obtained test pattern.

10. The method of claim 9, wherein the providing of the user interface comprises providing a screen for ordering a toner refill cartridge when the estimated result of a usage life satisfies a first condition or providing a screen for ordering a consumable whose usage life is estimated to be less than a certain amount when the estimated result satisfies a second condition.

11. The method of claim 10, further comprising:
performing an image optimization process for the image formation operation when a user does not order the toner refill cartridge or the consumable on the provided screen for ordering the toner refill cartridge or the provided screen for ordering the consumable.

12. The method of claim 11, wherein the performing of the image optimization process comprises:
determining an image adjustment value for performing the image formation operation using the test pattern or a new test pattern; and
applying the determined image adjustment value to the image forming apparatus.

13. The method of claim 8, wherein the determining of whether the toner is in the status of being required to be refilled comprises:
determining whether a remaining amount of a toner in a ready status of the image forming apparatus is less than a certain amount; and
determining whether a request of executing a diagnosis on the status of at least one consumable is received from a user.

14. The method of claim 8, wherein the method is performed in the image forming apparatus or a user device capable of communicating with the image forming apparatus.

15. A non-transitory computer-readable storage medium storing instructions executable by a processor, the non-transitory computer-readable storage medium comprising:
instructions to determine whether a toner in an image forming apparatus is in a status of requiring to be refilled;
instructions to determine a status of at least one consumable used in an image formation operation by using a test pattern when the toner is in the status of requiring to be refilled; and
instructions to provide a user interface corresponding to the determined status of the consumable.
